(19) United States
(12) Patent Application Publication
(10) Pub. No.: US 2026/0179796 A1
(43) Pub. Date: Jun. 25, 2026

(54) POROUS LEAD-FREE X-RAY SHIELDING MATERIAL AND MANUFACTURING METHOD THEREOF

(71) Applicant: PUKYONG NATIONAL UNIVERSITY INDUSTRY-UNIVERSITY COOPERATION FOUNDATION, Busan (KR)

(72) Inventors: Junghwan KIM, Busan (KR); Shanmugam MAHALINGAM, Busan (KR)

(73) Assignee: PUKYONG NATIONAL UNIVERSITY INDUSTRY-UNIVERSITY COOPERATION FOUNDATION, Busan (KR)

(21) Appl. No.: 18/840,879

(22) PCT Filed: Jul. 2, 2024
(86) PCT No.: PCT/KR2024/009303

§ 371 Date: Aug. 22, 2024

(30) Foreign Application Priority Data
Jul. 28, 2023 (KR) 10-2023-0098702

(51) Int. Cl. G21F 1/08; G21F 1/10

(52) U.S. Cl. CPC G21F 1/085; G21F 1/106

(57) ABSTRACT

A porous lead-free X-ray shielding material and a method for preparing the same are disclosed. The method for preparing the porous lead-free X-ray shielding material may include a first step of solidifying a mixture of sulfur-doped cerium oxide powders, a liquid PDMS binder, and a water-soluble precursor material for forming pores to form a solid, and a second step of dispersing the solid in water to form a plurality of pores therein. Thereafter, bismuth halide is loaded into the formed porous metal oxide structure, so that a composite material composed of the cerium metal oxide, PDMS, and bismuth halide may be finally obtained. In particular, the cerium metal oxide and bismuth halide are uniformly and densely distributed in the direction in which X-rays are irradiated, thereby enabling effective X-ray shielding.

### BACKGROUND

### Field of the Disclosure

The present disclosure relates to a method for preparing a porous lead-free X-ray shielding material that may replace a lead-based X-ray shielding material.

### Description of Related Art

Existing lead-based shielding materials have been most widely used due to advantages of ease processing and excellent X-ray shielding performance thereof. However, problems such as environmental problems, harmfulness to the human body, and poor wearing comfort as caused by the lead have been pointed out in various industries. Many researchers are conducting research for replacing the lead in the development of the shielding material to solve these problems. However, there are still chronic problems such as difficulty in uniformly dispersing substances in the shielding material and weight reduction of the shielding material.

Therefore, it is necessary to develop a lead-free shielding material that may have excellent X-ray shielding performance, as well as uniform dispersion, lightness, and flexibility, thereby replacing the existing lead shielding materials.

### SUMMARY OF THE INVENTION

One purpose of the present disclosure is to provide a method for preparing a porous lead-free X-ray shielding material that may have excellent X-ray shielding performance and may secure uniform dispersion, lightness, and flexibility.

Another purpose of the present disclosure is to provide a porous lead-free X-ray shielding material that may have excellent X-ray shielding performance and may secure uniform dispersion, lightness, and flexibility.

In order to achieve the purpose of the present disclosure, one aspect of the present disclosure provides a method for preparing a porous lead-free X-ray shielding material, the method comprising: a first step of solidifying a mixture of cerium oxide powders, a liquid PDMS binder, and a water-soluble pore-forming material to form a solid; and a second step of dispersing the solid in water to form a plurality of pores therein.

In one embodiment of the method, the cerium oxide powders are sulfur-doped cerium oxide (S-doped CeO₂) powders. The sulfur-doped cerium oxide powders may provide a high-efficiency X-ray shielding effect due to the electron donor role of sulfur.

In one embodiment of the method, the sulfur-doped cerium oxide powders are prepared by: ultrasonicating a solution containing the cerium oxide powders, methanol, and sulfuric acid to form an ultrasonication product; and drying the ultrasonication product.

In one embodiment, the cerium oxide powders may be cerium oxide powders doped with a material selected from nitrogen (N), boron (B), and an electron donor substituent.

In one embodiment of the method, the method further comprises a third step of introducing the porous solid prepared in the second step into a bismuth halide solution such that bismuth halide is loaded in the pores of the porous solid.

In one embodiment of the method, the bismuth halide includes Bi(I_{1-y}Br_{y})₃, where y is in a range of 0 to 1.

In one embodiment of the method, the water-soluble pore-forming material includes sodium chloride (NaCl) or ammonium hydrocarbon (NH₄HCO₃).

In order to achieve the purpose of the present disclosure, another aspect of the present disclosure provides a porous lead-free X-ray shielding material comprising a porous solid having a plurality of pores, wherein the porous solid includes a PDMS binder and cerium oxide (CeO₂) dispersed in the PDMS binder.

In one embodiment of the porous lead-free X-ray shielding material, the cerium oxide is sulfur-doped cerium oxide (S-doped CeO₂). The sulfur-doped cerium oxide powders may provide a high-efficiency X-ray shielding effect due to the electron donor role of sulfur.

In one embodiment of the porous lead-free X-ray shielding material, bismuth halide is loaded in the pores of the porous solid. The bismuth halide and the sulfur-doped cerium oxide may be uniformly distributed in the solid to provide a high X-ray shielding efficiency.

In one embodiment of the porous lead-free X-ray shielding material, the bismuth halide includes Bi(I_{1-y}Br_{y})₃, where y is in a range of 0 to 1.

The porous lead-free X-ray shielding material according to the present disclosure not only has excellent X-ray shielding performance, but is also harmless to the human body and the environment, and has lightweight and flexible mechanical properties, and thus may significantly improve the lightweight and performance of shielding clothing or equipment in the medical field, and may be utilized in other industries according to the demand.

In particular, the porous lead-free X-ray shielding material containing both sulfur-doped cerium oxide and bismuth halide according to the present disclosure may exhibit a synergistic effect of X-ray shielding performance because the two materials with excellent X-ray shielding performance are uniformly distributed in one material.

### BRIEF DESCRIPTION OF THE DRAWINGS

FIGS. 1 and 2. (a) in FIG. 1 shows a sulfonation reaction of CeO₂ according to one embodiment of the present disclosure, and (b) in FIG. 1 and FIG. 2 are diagrams schematically showing a method for preparing a porous lead-free X-ray shielding material according to one embodiment of the present disclosure.

FIGS. 3 to 7 are diagrams showing experimental results according to an experimental example of the present disclosure.

FIG. 8 is a schematic diagram showing a multicomponent X-ray shielding material including both a sulfur-doped cerium oxide and a bismuth halide composite material and an X-ray radiation shielding mechanism thereof.

### DETAILED DESCRIPTION OF THE INVENTION

Hereinafter, embodiments of the present disclosure will be described in detail with reference to the accompanying drawings. The present disclosure may have various changes and may have various forms. Thus, specific embodiments are illustrated in the drawings and described in detail herein. However, this is not intended to limit the present disclosure to a specific disclosure form. It should be understood that the present disclosure includes all changes, equivalents, or substitutes as included within the spirit and technical scope of the present disclosure. Similar reference numerals are used for similar components in describing the drawings.

The terminology used herein is directed to the purpose of describing particular embodiments only and is not intended to be limiting of the present disclosure. As used herein, the singular constitutes “a” and “an” are intended to include the plural constitutes as well, unless the context clearly indicates otherwise. It will be further understood that the terms “comprise”, “including”, “include”, and “including” when used in this specification, specify the presence of the stated features, integers, operations, elements, and/or components, but do not preclude the presence or addition of one or more other features, integers, operations, elements, components, and/or portions thereof.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The present disclosure provides a method for preparing a porous lead-free X-ray shielding material that not only may have excellent X-ray shielding performance but also may secure uniform dispersibility, lightness, and flexibility of the shielding material.

According to one embodiment of the present disclosure, the method for preparing a porous lead-free X-ray shielding material may include a first step of solidifying a mixture of cerium oxide powders, a liquid PDMS binder, and a water-soluble pore-forming material, and a second step of dispersing the solidified mixture in water to form a plurality of pores.

The first step is a step of solidifying the mixture of cerium oxide powders, a liquid PDMS binder, and a water-soluble pore-forming material.

The above cerium oxide (CeO₂) powder is a material having X-ray shielding performance. The above cerium oxide (CeO₂) powders may be mixed with the liquid PDMS binder and the water-soluble pore-forming material and then the mixture may be solidified to form a solid in which cerium oxide (CeO₂) and the pore-forming material are uniformly dispersed in the PDMS binder.

In one embodiment, the cerium oxide powders may be sulfur-doped cerium oxide powders (S-doped CeO2). When the sulfur-doped cerium oxide powders are used as the shielding material, it may provide a high-efficiency X-ray shielding effect due to the electron donor role of sulfur.

In one embodiment, the sulfur-doped cerium oxide powders may be prepared by a method including a step of ultrasonicating a solution containing cerium oxide powders, methanol, and sulfuric acid, and a step of drying the ultrasonicating product (see FIG. 2). Sulfur (sulfonic acid) may be chemically bonded to the cerium oxide powders through the ultrasonication.

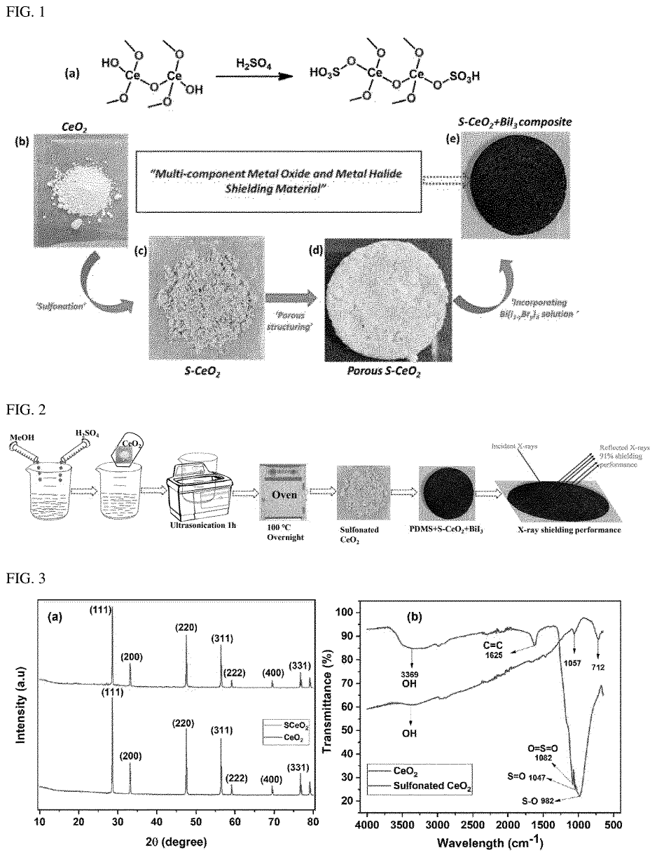

More specifically, as shown in (a) in FIG. 1, the sulfonic acid (—SO₃H) group formed on the surface of cerium oxide (CeO₂) during the sulfonation process may be chemically bonded to the CeO₂ structure. Since sulfur is an electron-donating element, this sulfonation process may effectively increase the electron density of cerium oxide, thereby increasing the radiation shielding performance.

In one example, the water-soluble pore-forming material is a material that is used to form a plurality of pores by dispersing only the solid obtained through the first step in water such that the pore-forming material dispersed in the solid is dissolved to form the pores. In one embodiment, the water-soluble pore-forming material may be selected from materials that may be used as a space holder, such as sodium chloride (NaCl), ammonium bicarbonate (NH₄HCO₃), and the like, but is not particularly limited thereto.

The second step is a step of dispersing the solid in water to form the plurality of pores. As described above, the solid is present in a state in which the cerium oxide powders and the pore-forming material are uniformly dispersed in the PDMS binder. When the solid is dispersed in water, the pore-forming material is dissolved in the water, so that a large number of pores may be formed in the solid. In one embodiment, the process of dispersing the solid in water may include introducing the solid into water and ultrasonicating the solution. However, the present disclosure is not particularly limited thereto.

In one example, the method of the present disclosure may further include a third step of introducing the porous solid prepared after the second step into a bismuth halide solution such that the bismuth halide is loaded in the pores of the porous solid (see (b) in FIGS. 1 and 2).

The bismuth halide is a material having X-ray shielding performance, and is not solidified via binding of the PDMS solution. Therefore, the present disclosure provides a method of preparing the porous solid through the first and second steps, and then introducing the bismuth halide solution thereto such that the bismuth halide is loaded in the pores of the porous solid, thereby allowing the two materials having excellent X-ray shielding performance to be uniformly distributed in one material, and exhibiting a synergistic effect of X-ray shielding performance.

The porous lead-free X-ray shielding material including both sulfur-doped cerium oxide and bismuth halide according to one embodiment of the present disclosure may exhibit a synergistic effect of uniform distribution and the best X-ray shielding performance.

In one embodiment, the bismuth halide may include Bi(I_{1-y}Br_{y})₃ (y is 0 to 1), but is not particularly limited thereto.

In one example, the porous lead-free X-ray shielding material according to another embodiment of the present disclosure may include a porous solid having cerium oxide dispersed in the PDMS binder, and having a plurality of pores.

In one embodiment, the cerium oxide may be sulfur-doped cerium oxide (S-doped CeO₂). The sulfur-doped cerium oxide may provide a high efficiency X-ray shielding effect due to the electron donor role of sulfur.

In one embodiment, a bismuth halide may be loaded in the pores of the porous solid. In this regard, the bismuth halide may include Bi(I_{1-y}Br_{y})₃ (y is 0 to 1), but is not particularly limited thereto.

The lead-free X-ray shielding material of the present disclosure in which bismuth halide is loaded into the pores of the porous solid and cerium oxide is uniformly dispersed in the PDMS binder, may provide uniform distribution of the shielding material and excellent shielding efficiency due to the combination of the two materials with excellent shielding performance. In particular, the porous lead-free X-ray shielding material containing both sulfur-doped cerium oxide and bismuth halide according to the present disclosure may exhibit a synergistic effect of the highest X-ray shielding performance (91.8% in the energy range of 60 kV).

Furthermore, the porous lead-free X-ray shielding material according to the present disclosure not only has excellent X-ray shielding performance, but is also harmless to the human body and the environment, and has lightweight and flexible mechanical properties, and thus may significantly improve the lightweight and performance of shielding clothing and equipment in the medical field, and may be utilized according to the demands of other industries.

Hereinafter, specific examples of the present disclosure will be described in detail. However, the examples as set forth below are only some embodiments of the present disclosure, and the scope of the present disclosure is not limited to the examples as set forth below.

### Example 1: PDMS-CeO₂ Preparation

Liquid PDMS (polydimethylsiloxane), cerium oxide powders (CeO₂), and NaCl were mixed with each other at a weight ratio of 1:0.1:1.5. The mixed solution was centrifuged three times at 8,000 rpm for 20 minutes at room temperature in a centrifuge to remove excess PDMS, and then solidified under heat treatment at 60° C. for 18 hours. The solid was cut into a coin shape 3 mm thick, and 25 mm in diameter, and NaCl was removed therefrom using an ultrasonic washer (60° C., 18 hours), thereby preparing a porous solid (PDMS-CeO₂) having numerous pores.

### Example 2: PDMS-S—CeO₂ Preparation

A mixture of sulfuric acid and methanol (20 mL of methanol and 15 mL of 1 M H₂SO₄) containing about 1 g of CeO₂ nanostructures was strongly sonicated for about 2 hours. Next, the sonification product was dried at 100° C. for 24 hours to prepare sulfur-doped cerium oxide powders (S—CeO₂).

Thereafter, liquid PDMS (polydimethylsiloxane), the sulfur-doped cerium oxide powders (S-doped-CeO₂), and NaCl were mixed with each other at a weight ratio of 1:0.1:1.5. The mixed solution was centrifuged three times at room temperature at 8000 rpm for 20 minutes in a centrifuge to remove excess PDMS, and then heat-treated at 60° C. for 18 hours to solidify the mixed solution. The solid was cut into a coin shape 3 mm thick and 25 mm in diameter, and NaCl was removed therefrom using an ultrasonic washer (60° C., 18 hours) to prepare a porous solid (PDMS-S—CeO₂) with numerous pores.

### Example 3: Preparing PDMS/S-CeO₂/BiI₃

The bismuth halide mixed powders were prepared by mixing Bib powers and BiBr₃ powders with each other in a vial at a weight ratio of BiI₃/BiBr₃ as shown in Table 1 as set forth below. Thereafter, 3 ml of THF was added to each vial, and the bismuth halide mixed powders (1.0 g) was dissolved using a stirrer.

TABLE 1

| Sample name | A0 | A2 | A4 | A6 | A8 | A10 |
|---|---|---|---|---|---|---|
| A powder (g) | 0 | 0.2 | 0.4 | 0.6 | 0.8 | 1 |
| BiBr₃ | | | | | | |
| B powder (g) | 1 | 0.8 | 0.6 | 0.4 | 0.2 | 0 |
| BiI₃ | | | | | | |

Thereafter, PDMS-S—CeO₂ as prepared according to Example 2 was loaded into the bismuth halide solution and then mixed solution was dried at 60° C. for 30 minutes such that THF was removed therefrom, and bismuth halide (Sample AG-A10) was loaded into the pores.

### Experimental Example 1: Analysis of Synthesis Results

(a) in FIG. 3 is an X-ray diffraction pattern graph of each of pure CeO₂ powders and S—CeO₂ powders, and (b) in FIG. 3 is the FT-IR analysis result thereof.

As shown in (a) in FIG. 3, the corresponding crystal plane of CeO₂ (before sulfonation) exhibited prominent and unique peaks detected at 28.56(111), 33.12(200), 47.59(220), 56.39(311), 59.14(222), 69.52(400), and 76.86(331) at the 20 scale. This result is consistent with the cubic fluorite structure of CeO₂.

The XRD graph result of sulfonated S—CeO₂ exhibited peaks that were almost similar to those of CeO₂ powders, thus indicating that the presence of sulfur did not affect the crystallinity. Furthermore, the absence of any discernible change in peak shifts indicates that the sulfonation does not affect the surface area and the crystal size.

In one example, referring to (b) in FIG. 3, the O—H stretching vibration of the OH group of the pure CeO₂ acts as the cause of the broad band at 3369 cm⁻¹. The CO₂ asymmetric stretching vibration corresponds to the band at 712 cm⁻¹, and the CO stretching vibration corresponds to the band at 1057 cm⁻¹, respectively.

The band observed on S—CeO₂ indicates that a structure thereof is substantially different from that of the pure CeO₂. The peaks observed at 1082, 1047, and 982 cm⁻¹ correspond to the stretching vibrations of O═S═O, S═O, and S—O groups in the sulfonic acid group of the S—CeO₂ nanostructure, respectively. The sulfonic acid (—SO₃H) group absorbs a peak near 3369 cm⁻¹, which is similar to the stretching vibration of the water molecule (—OH). From these FTIR analysis results, it was identified that the sulfonic acid group was introduced to the surface of CeO₂ nanostructures through the chemical reaction during the sulfonation process.

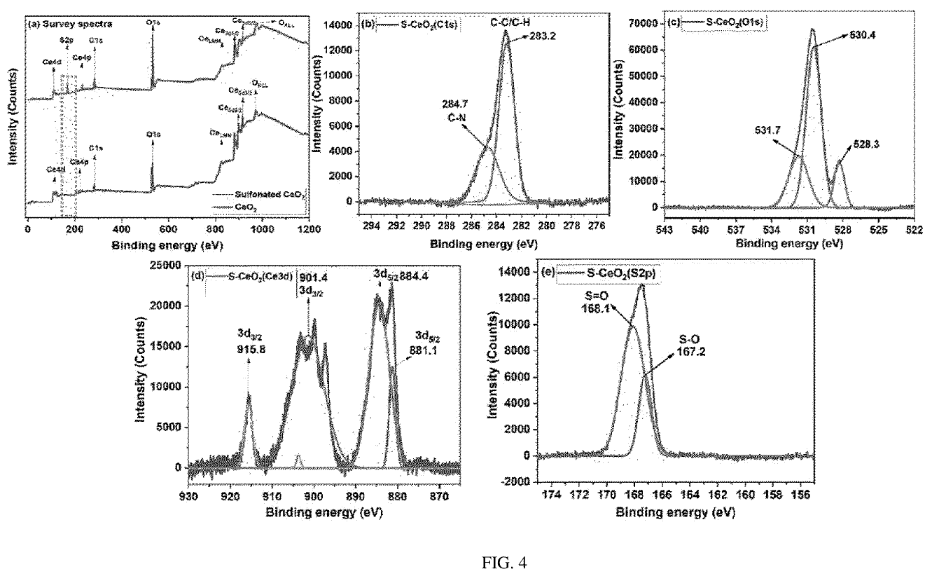

(a) in FIG. 4 shows the XPS spectra of the CeO₂ powders and the S—CeO₂ powders. The presence of all elements such as Ols, Ce4p, and Ce4d was observed from the XPS spectra of the CeO₂ powders and the S—CeO₂ powders. Furthermore, a new peak with a binding energy of 167 eV was observed from the S—CeO₂ XPS spectrum, which is attributed to the S2p component of the sulfonic acid group binding to CeO₂.

(b) and (c) in FIG. 4 show the CIs and Ols spectra of the S—CeO₂ powders. As shown in (b) in FIG. 4, the peak was split into two peaks at 284.7 and 283.2 eV respectively corresponding to C—N and C—C/C—H.

Further, referring to (c) in FIG. 4, the deconvolution of the Ols electron core level spectrum indicates three distinct oxygen species, and a high intensity peak at 530.4 eV related to the CeO₂ lattice O is observed. Furthermore, the oxygen-deficient region (O attached to Ce³⁺) in the CeO₂ matrix and the other two peaks with high binding energies (531.7 and 528.3 eV) are attributed to adsorbed oxygen or a hydroxyl group present in the lattice vacancy.

(d) in FIG. 4 is a high-resolution Ce3d spectrum of the S—CeO₂ powders, showing four peaks that may be attributed to the spin-orbit splitting at Ce 3d_{5/2} and Ce 3d_{3/2}, respectively. Due to this spin doublet splitting, CeO₂ may be found to be present in both Ce³⁺ and Ce⁴⁺ oxidation states. The distinctive XPS signals at 884.4 and 901.4 eV are respectively attributed to the Ce⁴+3d_{5/2} and Ce³⁺ 3d_{3/2} electron states. Two additional satellite peaks were observed at 881.1 and 915.8 eV, respectively, due to Ce³⁺ 3d_{5/2} and Ce⁴+3d₃/2. The presence of cerium of the mixed atoms of Ce³⁺ and Ce⁴⁺ was identified through these spectra. The base peaks at 884 and 901 eV indicate the relative amounts of Ce³⁺ and Ce⁴⁺.

The presence of oxygen vacancies in CeO₂ is identified based on an area size of the individual peak, and the concentration of Ce⁴⁺ is relatively higher. It was identified that a difference between binding energy of these two states was 17 eV.

Furthermore, the sulfonic groups on the CeO₂ surface exhibited peak values at 168.1 and 167.2 eV for S 2p_{1/2} and 2p_{3/2} in the S2p spectrum of S—CeO₂ ((e) in FIG. 4), which are attributed to S═O and S—O, respectively.

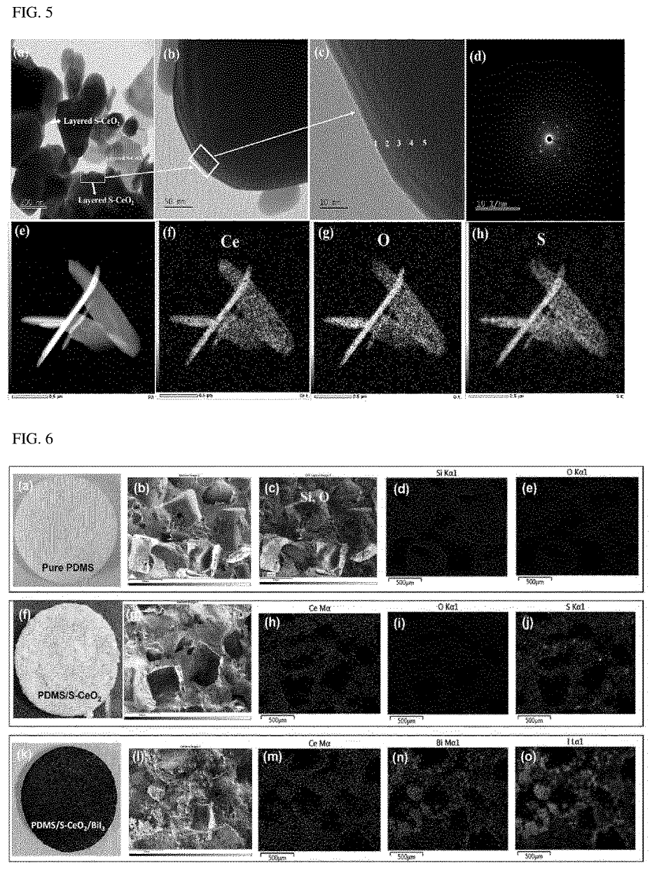

(a) to (c) in FIG. 5 are HR-TEM images of S—CeO₂ powders observed at various magnifications.

As shown in (a) to (c) in FIG. 5, it is observed that S—CeO₂ crystals with a diameter of 100 to 200 nm are dispersed. The S—CeO₂ crystal has a structure such as a thin and transparent semi-hexagonal plate, and a laminated layer is observed at an edge thereof.

A marked area represents the S—CeO₂ with a layered structure having a thin layer, and the layered structure allows the sulfate groups to bind to the CeO₂ crystal to enhance the electron density and X-ray shielding activity.

(b) in FIG. 5 shows the enlarged image of (a) in FIG. 5, clearly showing the layered structure of the S—CeO₂ crystal. (c) in FIG. 5 is a high-magnification image of (b) in FIG. 5. Based on (c) in FIG. 5, it is identified that a five layered structure is present at the edge of the S—CeO₂ crystal and the lattice pattern of the S—CeO₂ crystal is observed.

The SAED pattern of the S—CeO₂ crystal structure is shown in (d) in FIG. 5, showing the high crystallinity of S—CeO₂ and the ring index of the cubic fluorite structure thereof.

Further, EPMA (Field emission electron probe micro-analysis) was performed on S—CeO₂, and the elemental mapping and related energy dispersion spectra are shown (e) to (h) in FIG. 5.

As a result, cerium, oxygen, and sulfur components were found to be uniformly distributed throughout the composition. In particular, sulfur was integrated onto the CeO₂ layer, as shown in (h) in FIG. 5. Based on these results, it was identified that sulfur was well distributed in the cerium oxide particles, which was consistent with the FT-IR and XPS results.

Next, the morphologies of pure porous PDMS, PDMS/S—CeO₂ (Example 2), and PDMS/SCeO₂/BiI₃ (Example 3) were identified through FE-SEM images using energy-dispersive X-ray (EDX) spectroscopy and element mapping studies.

As shown in FIG. 6, the pure porous PDMS ((a) to (e) in FIG. 6) exhibited a structure with interconnected channels and a porous surface. This porous structure enables the integration of multicomponent sulfonated cerium oxide and bismuth halide composite. (c) to (e) in FIG. 6 shows that the pure porous PDMS contains Si and O components, and additionally shows that Si and O are evenly distributed throughout the pure PDMS structure.

(f) to (j) in FIG. 6 shows that the surface of PDMS/S—CeO₂ is porous and spongy. Specifically, the surface morphology of PDMS/S—CeO₂ exhibits high porosity and a sponge structure. Furthermore, it was identified that S—CeO₂ nanostructures were evenly distributed throughout the PDMS matrix.

Furthermore, (f) to (j) in FIG. 6 shows that PDMS/S—CeO₂ contains Si and O elements, and Ce and S are evenly distributed throughout the PDMS structure.

(k) to (o) in FIG. 6 shows that bismuth halide ions of PDMS/S-CeO₂/BiI₃ penetrate into the porous structure and coagulate on the pore surface (or in the pore) of the PDMS/S-CeO₂ composite. Furthermore, the SEM image of PDMS/S-CeO₂/BiI₃ shows that Bib particles are evenly dispersed throughout the PDMS matrix. S—CeO₂ acts as a scaffold for Bib particles, and Bib particles are loaded into the pores of the PDMS matrix so as to be evenly dispersed throughout the PDMS matrix. As a result, the composite material with unique properties may be prepared. (m) to (o) in FIG. 6 shows the uniform distribution of cerium (Ce), bismuth (Bi), and iodide (I) in PDMS/S-CeO₂/BiI₃.

Experimental Example 2: Evaluation of X-ray shielding performance

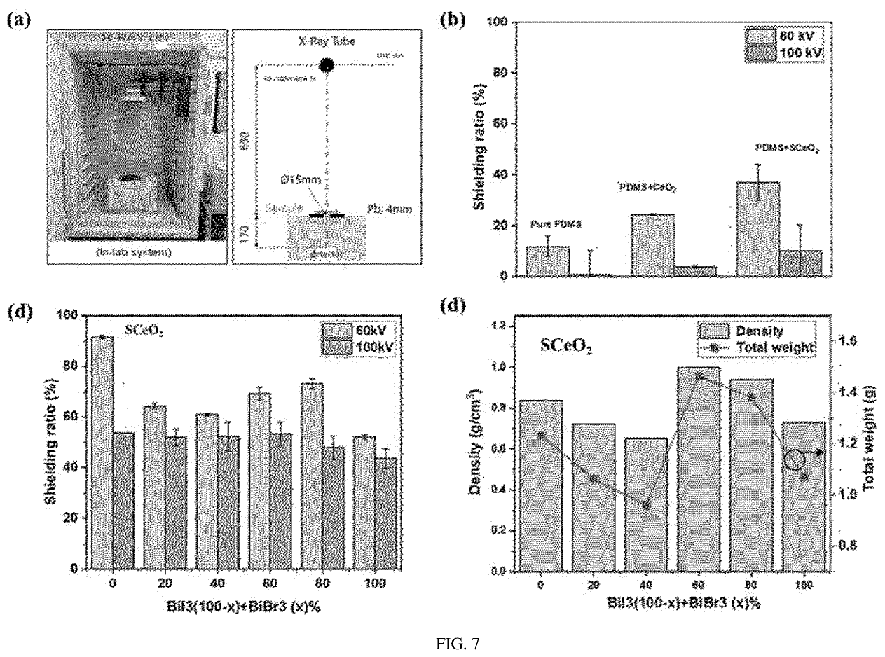

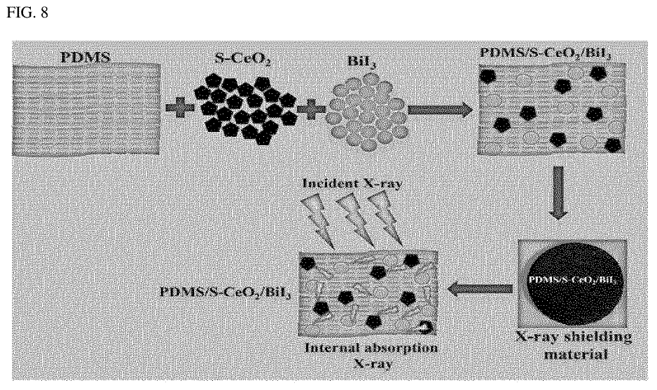

FIG. 7 shows the result of investigating the X-ray shielding performance of PDMS/S-CeO₂/BiI₃/BiBr₃ multicomponent composite.

(a) in FIG. 7 is an image of an X-ray device in a laboratory environment, and (b) in FIG. 7 shows the X-ray shielding performance of each of the pure PDMS, PDMS/CeO₂ (Example 1), and PDMS/S—CeO₂ (Example 2).

The pure PDMS exhibited a low X-ray shielding performance of lower than 20% at 60 and 100 kV. PDMS/CeO₂ (Example 1) exhibited a slightly increased X-ray shielding performance compared to that of the pure PDMS, and PDMS/S—CeO₂ (Example 2) exhibited a significantly higher X-ray shielding performance than that of each of the pure PDMS and Example 1.

The pure PDMS is not effective as an X-ray shielding material, so that X-rays penetrate the pure PDMS without being absorbed and scattered thereby. Adding CeO₂ metal oxide with a high atomic number and a high density to the pure PDMS slightly increases the shielding performance. Doping sulfur into the CeO₂ nanostructures increases the electron density of the metal oxide, thereby increases the opportunity for X-ray photons to interact with electrons, thereby lowering the energy of the photons and weakening the X-ray beam.

Specifically, in the PDMS/S—CeO₂ (Example 3), sulfur helps in X-ray shielding by attenuating X-rays through a process known as photoelectric absorption. This occurs when an X-ray photon interacts with an electron of an atom, thereby releasing an electron to form an ion pair, and the energy of the X-ray photon is then absorbed by the atom, thereby lowering the energy of the photon and weakening the X-ray beam.

However, PDMS/S—CeO₂ (Example 3) still has a partial area of PDMS with low attenuation and an empty space. Therefore, in order to improve the X-ray shielding performance, bismuth halide was loaded and incorporated into the pores of PDMS/S—CeO₂. After drying, bismuth halide may cover the surface of PDMS and may be loaded into the pores to fill the empty spaces of the composite material.

(c) in FIG. 7 shows the X-ray shielding performance of PDMS/S-CeO₂/BiX₃ (X is I or Br) based on a composition ratio of Bib and BiBr₃.

The X-ray shielding performance evaluation was performed at 60 kV and 100 kV, and the BiBr₃ 0 wt % (BiI₃) sample exhibited excellent X-ray shielding performance of 91.8% at 60 kV. On the other hand, the sample with 1 wt % BiBr₃ content exhibited the lowest X-ray shielding performance.

Although BiBr₃ has a higher attenuation cross-section than that of Bib, Bib exhibited the best X-ray shielding performance due to its higher electron density than that of BiBr₃.

The distinct hierarchical porous structure of PDMS improves the loading and dispersion of S—CeO₂, resulting in a large number of random collisions of light photons and a reduction in secondary radiation during X-ray irradiation. Furthermore, the X-ray shielding efficiency of the shielding material increases because bismuth halide (Bib) which absorbs X-rays scattered within the pores is loaded therein and is dispersed throughout the PDMS matrix.

(d) in FIG. 7 shows the result of measuring a density and a weight based on a loading ratio of Bib and BiBr₃ in PDMS/S—CeO₂.

The volume of all samples was 1.47 cm⁻³, and a total weight of PDMS/S-CeO₂/BiI₃ was measured to be 1.25 g and a density thereof was 0.85 cm⁻³. In addition, all composites exhibit low densities lower than 1 g cm⁻³, and thus may be utilized as lightweight X-ray shielding materials.

Through these results, it was identified that the PDMS/S-CeO₂/BiI₃ composite exhibited the highest X-ray shielding ability.

FIG. 8 is a schematic diagram of a multicomponent X-ray shielding material containing sulfur-doped cerium oxide and bismuth halide composite and an X-ray radiation shielding mechanism thereof.

As shown in FIG. 8, the sulfonated CeO₂ structure (S—CeO₂) and PDMS chains of the multicomponent composite are bonded to each other via hydrogen bonds, thereby providing a high surface area-to-volume ratio for radiation shielding.

Specifically, X-rays are attenuated by three different mechanisms: internal multiple reflections, absorption losses, and reflection losses). Reflections on the surface of the shielding material contribute to reflection losses. Absorption losses occur as X-rays pass through the shielding material due to numerous reflections and transmissions therein.

Sulfur may act as an X-ray shielding agent by attenuating X-rays through a process called photoelectric absorption. This process occurs when an X-ray photon interacts with an electron of an atom, thereby releasing an electron and creating an ion pair. The energy of the X-ray photon is absorbed by the atom, thereby reducing the energy of the photon and attenuating the X-ray beam. Sulfur is a relatively heavy element with many electrons, thereby effectively attenuating the X-rays through photoelectric absorption.

While the present disclosure has been described above with reference to preferred embodiments of the present disclosure, it will be understood by those skilled in the art that various modifications and variations may be made to the present disclosure without departing from the spirit and scope of the present disclosure as set forth in the claims below.

1. A method for preparing a porous lead-free X-ray shielding material, the method comprising:
a first step of solidifying a mixture of cerium oxide powders, a liquid PDMS binder, and a water-soluble pore-forming material to form a solid; and
a second step of dispersing the solid in water to form a plurality of pores therein.

2. The method for preparing the porous lead-free X-ray shielding material of claim 1, wherein the cerium oxide powders are sulfur-doped cerium oxide (S-doped CeO₂) powders.

3. The method for preparing the porous lead-free X-ray shielding material of claim 2, wherein the sulfur-doped cerium oxide powders are prepared by:
ultrasonicating a solution containing the cerium oxide powders, methanol, and sulfuric acid to form an ultrasonication product; and
drying the ultrasonication product.

4. The method for preparing the porous lead-free X-ray shielding material of claim 1, wherein the method further comprises a third step of introducing the porous solid prepared in the second step into a bismuth halide solution such that bismuth halide is loaded in the pores of the porous solid.

5. The method for preparing the porous lead-free X-ray shielding material of claim 4, wherein the bismuth halide includes Bi(I_{1-y}Br_{y})₃, where y is in a range of 0 to 1.

6. The method for preparing the porous lead-free X-ray shielding material of claim 1, wherein the water-soluble pore-forming material includes sodium chloride (NaCl) or ammonium hydrocarbon (NH₄HCO₃).

7. A porous lead-free X-ray shielding material comprising a porous solid having a plurality of pores, wherein the porous solid includes a PDMS binder and cerium oxide (CeO₂) dispersed in the PDMS binder.

8. The porous lead-free X-ray shielding material of claim 7, wherein the cerium oxide is sulfur-doped cerium oxide (S-doped CeO₂).

9. The porous lead-free X-ray shielding material of claim 7, wherein bismuth halide is loaded in the pores of the porous solid.

10. The porous lead-free X-ray shielding material according to claim 9, wherein the bismuth halide includes Bi(I_{1-y}Br_{y})₃, where y is in a range of 0 to 1.
